(19) United States
(12) Patent Application Publication
(10) Pub. No.: US 2008/0239082 A1
(43) Pub. Date: Oct. 2, 2008

(54) HDMI format video pattern and audio frequencies generator for field test and built-in self test

(75) Inventors: Ning Zhu, San Jose, CA (US); Jianbin Hao, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Analogix Semiconductor, Inc.

(21) Appl. No.: 11/731,607

(22) Filed: Mar. 29, 2007

(51) Int. Cl. H04N 17/00

(52) U.S. Cl. 348/181; 348/E17.001

(57) ABSTRACT

A versatile video pattern and audio pattern generation module, that can be integrated onto a video integrated circuit (IC) to generate functional video test input data, in HDMI format, for gray bars, color bars and moving bar data patterns, and to further generate single-tone audio signals, is disclosed. This video signal generator can be made part of the built-in-self test (BIST) to allow simplified testing of the IC. The signals generated can be used to test the video and audio functionality, as well as enabling a system to be demonstrated in the field. The output of the generator during the demonstration can be displayed using any suitable video display enabling simplified demonstration set-up. These video and audio signals can bemused as a diagnostic tool by the consumer and also for debugging the IC and system as may be necessary.

### BACKGROUND OF THE INVENTION

1. Field of the Invention

The present invention relates to the field of display system functionality tests and demonstrations, and more specifically to the generation of HDMI compliant video and audio signals on an integrated circuit or at least in HDMI systems for use with BIST and for in-the-field demonstration of functionality and debugging.

2. Prior Art

Video and display systems are becoming commodity products as there are a large number of manufacturers in the market. The price of the video systems is coming down over time. This has put pressure on the system manufacturers to find ways to reduce the cost associated with manufacturing, testing, marketing and selling of video systems. The manufacturing cost of the chips and associated systems are brought down by using finer technologies, such as deep sub-micron technologies, and by increased integration of the multiple functions onto a single integrated circuit (IC), also known as a chip, thereby reducing the number of ICs used in any single system. Over the past decade the manufacturing cost for ICs have generally followed Moore's law for increased density and reduced cost and hence price.

The test costs on the other hand have not gone down, in fact these costs have increased with the chip complexity. In order to reduce the cost associated with chip test, built-in-self-test (BIST) has become more common. These use functional and algorithmic tests integrated into the chip enabling the test after manufacture. These BIST circuits generate various digital patterns to provide inputs to the IC which produce known outcomes at the outputs. By comparing the outputs to expected outputs, the chip testing can be accomplished. The testing using BIST has been able to reduce the test cost of complex chips while providing reasonable test coverage, ensuring the outgoing quality of the parts.

In the area of marketing and sales, there are three areas where costs are high: 1) the cost of functional demonstrations; 2) the cost of returns; and, 3) the cost of in-the-field debugging and repair. Typically demonstration of functionality to the customer of the product purchased is difficult. This is due to the fact that there are a number of external components that need to be correctly connected to the system to ensure a good functional demonstration. But if this can be done and the functionality shown to the customer, with minimum effort and time, the result is a happy purchaser of the product and the store can ensure improved customer loyalty. The cost of return of commodity products as faulty in the field is becoming a major drain on the profitability of companies. The solution suggested has been to increase the testing of the chips and systems to ensure more complete test coverage to prevent problems of functionality in the field. This has the negative effect of increasing the test cost. A good solution has not been forth coming until now. The marketing costs for video systems are also affected by the add-on cost of complex equipment like high cost pattern generators and frequency generators that are needed for checking and debugging these systems. These equipment costs are in addition to the cost of either product return or a truck roll for on site repair.

It would therefore be advantageous for the purpose of overcoming the deficiencies of prior art solutions to provide a solution that will enable in-field test and demonstration. It would be further advantageous if such solution would provide a plurality of video and audio signals that are compatible with the high definition multimedia interface (HDMI) format.

### BRIEF DESCRIPTION OF THE DRAWINGS

FIG. 1 is a block diagram of a transmitter chip with the integrated signal generators in accordance with one embodiment of the present invention.

FIG. 2 is a block diagram of the audio waveform and video frame generators and their connection to the HDMI transmitter of the embodiment of FIG. 1.

FIG. 3 presents the generated video patterns: a. gray bars, b. color bars, and, c. moving bars.

FIG. 4 is a diagram showing the control functions in the video generator and the regions of the display they control.

### DETAILED DESCRIPTION OF THE PREFERRED EMBODIMENTS

A built-in video functional pattern generator circuit, preferably but not necessarily integrated into an integrated circuit (IC), otherwise referred to as a chip, to output the basic video signals that are typically gray bars, color bars and moving bars, without the need of an external pattern generator, is disclosed. The typical video generator is a digital circuit that can be easily integrated into any IC. An integrable audio generator circuit that will generate a single tone sine wave, the frequency and amplitude of which can be adjusted is also disclosed. The use of these functional pattern generators as part of the built-in self-test (BIST) circuit for manufacturing test is also part of the current disclosure.

These generated video patterns and audio tone will be available for self checking of the circuit in the field and also act as proof of functionality of the IC. The generated video signal output is typically in high definition multimedia interface (HDMI) format, and will ease the system level compliance test requirement in the field. It provides a powerful marketing tool by enabling the functionality showoff of the unit (system) being sold at the time of sale. It further enables the tuning of the system performance, as may be necessary, on site, to forestall any unnecessary returns due to system performance being impacted by being off tune. The implementation of this in-field demonstration will help improve customer confidence and increase customer loyalty. It will also reduce the returns due to sale of damaged or faulty systems to the consumer and hence improve profitability for the company. The simple functional test modes built in can also be used by the consumer to make sure that the system is operating within acceptable limits after installation or while in use. Using the output of the generators, the consumer can check and ensure correct functionality of system, and hence avoid unnecessary service calls. The built in generators can also be a valuable tool in debugging problems in the field by the service technicians. It eliminates the need for the technicians to carry various standalone signal and pattern generators during a service visit. In a typical chip, the video and audio generators are made part of the BIST so that they can be used for functional checking of the IC and the system. Having the capability to perform BIST has the advantage of reducing the system level compliance testing and fault diagnostic effort, thereby reducing the overall cost of the system to the consumer.

The exemplary and non-limiting embodiment of the video signal generator disclosed is capable of generating various video timing formats. Typically it covers the timing range from 25 MHz to 165 MHz, depending on the input clock frequency. The video generator design is such that the video timing format can be controlled by a number of parameters such that the display can be easily adjusted to suit the current and future display screen needs. Additionally, the capability to generate signals in any of the HDMI formats enable the generator to be used with different types of displays, having differing active number of lines per frame, active pixels per line and also differing refresh rate requirements.

The typical audio waveform generator generates a single, pre-settable frequency sinusoidal audio waveform of changeable amplitude. It is assembled into audio packets before being sent out to the link using transition minimized differential signaling (TDMS) protocol and connectivity for processing and transmission.

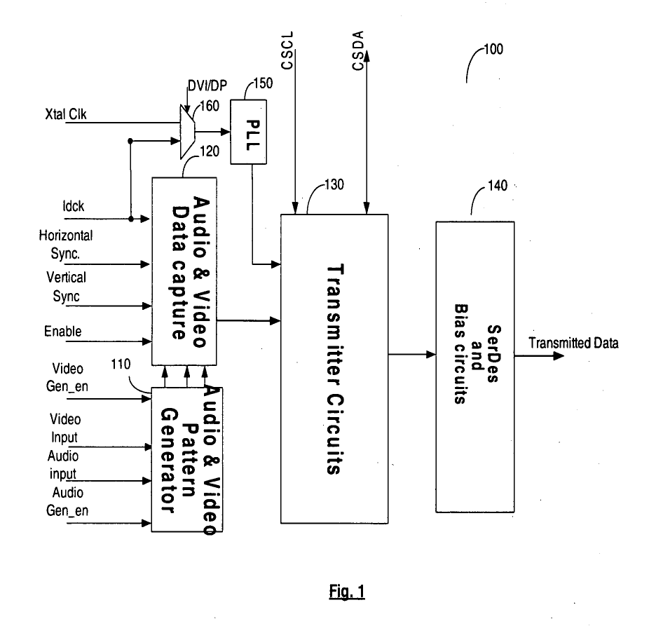

FIG. 1 is a block diagram 100 of a transmitter chip that has the audio & video pattern generator 110 integrated into it. The generated video signal or the input video stream can be selected by the use of the external input ‘Video Gen_en’ signal. Similarly the generated audio waveform or the incoming audio can be selected by the ‘Audio Gen_en’ signal. The selected signals are then sent to the audio & video data capture block 120 for buffering and then through the normal processing in the transmitter 130. Then, the signal is sent to the SerDes 140 to be transmitted to the sink device such as a TV with HDMI input. The present disclosure specifically relates to the integrated audio & video pattern generator block 110 and its application.

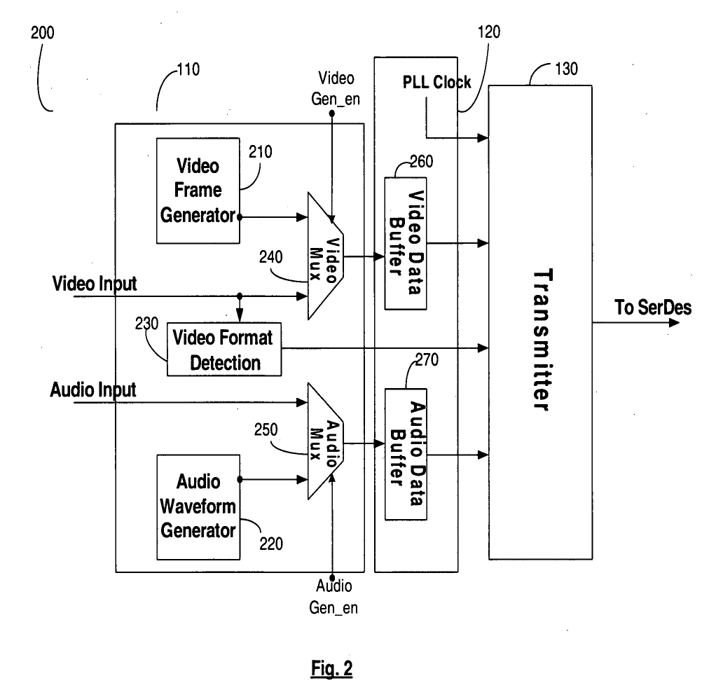

FIG. 2 is a detailed diagram 200 of the audio & video pattern generator block 110 and the audio & video data capture block. The main video input stream and the output of the video generator 210 are input to a video multiplexer 240. Based on the status of the ‘Video Gen-en’ signal, the multiplexer 240 will pass through to the video buffer 260 the video input stream or the generated video signal. This signal is buffered in the video data buffer 260 of the audio & video data capture block 120 and sent onward to be processed through the transmitter block 130 and SerDes 140 and transmitted to the display. Similarly the audio input is multiplexed with the generated audio waveform from the audio waveform generator 220 using the audio multiplexer 250 and, based on the status of the ‘Audio Gen_en’ signal, the selected input is passed to the audio data buffer 270 in the audio & video data capture block 120. This signal is processed by the transmitter 130 and the SerDes 140 and is sent as the audio output.

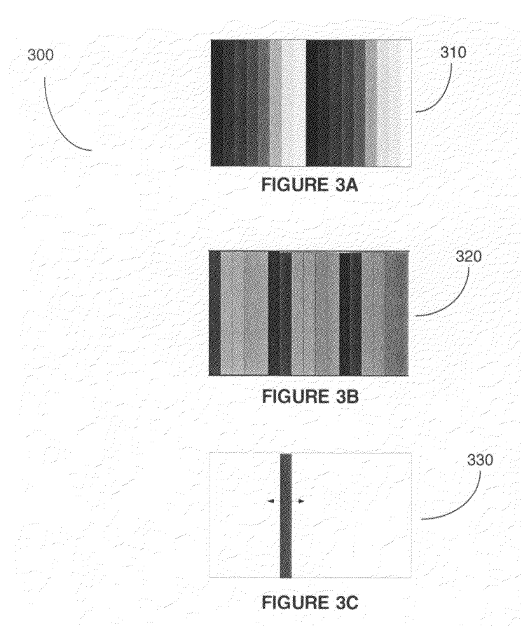

The integrated video frame generator 210 can be designed to have any number of suitable display patterns. What is disclosed, without limiting the general capabilities, is a video generator producing three typical patterns of video signals in the HDMI format. The three typical outputs 300 that are produced from the generator are shown in FIG. 3. FIG. 3A shows a grey bars 310 used to adjust the black and white contrast of the display, FIG. 3B shows the color bars 320 used for adjusting the color balance, and FIG. 3C shows the moving bar 330. The generator can be designed to generate additional test signal patterns, if it is so desired. Specifically, the integrated video frame generator can also be integrated into the BIST circuit to enable functional testing of the circuits, subsystem and systems in manufacturing while providing the capability of functional demonstration of the system in the field and also provide debugging capabilities in the field.

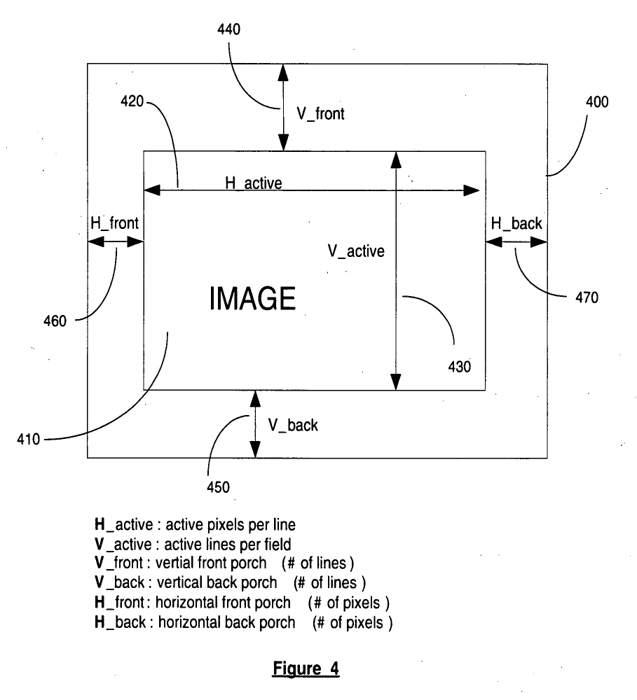

The integrated video frame generator 210 of FIG. 2 is also capable of generating signals in any of the HDMI video formats, changing the active number of lines per frame, active pixels per line, the refresh rate, etc. The generated signal controls the timing formats to cover all available display requirements. In FIG. 4, the total controlled display space 400 is shown. This can be divided into the actual image display area 410 defined by the H-active 420 and the V-active 430, the vertical porch areas of V-Front 440 and V-back 450 and the Horizontal porch areas of H-Front 460 and H-Back 470. The generator is typically designed to have control over all these parameters, H-active, for providing control of active pixels per line; V-active, for determining the active lines per field; V-front, defining the number of lines in the vertical front porch; V-back, for defining the number of lines in the vertical back porch; H-front, for controlling the number of pixels in the horizontal front porch; and H-back, for controlling the number of pixels in the horizontal back porch. The effects of these parameters on the display are also shown in FIG. 4.

The Integrated Audio generator 220 of FIG. 2 is capable of providing a single frequency waveform, the amplitude of which can be adjusted. It is possible to provide the capability of changing the frequency of the audio signal when necessary. This signal can be used effectively to demonstrate the capability and functionality of the audio components of the IC and the audio functional capability of the system in the field. This can also be used for audio system debugging in the field. The audio waveform generator can also be integrated into the BIST circuit to test the functional performance of the integrated chip and/or system at manufacturing test.

Thus while a certain preferred embodiment of the present invention has been disclosed and described herein for purposes of illustration and not for purposes of limitation, it will be understood by those skilled in the art that various changes in form and detail may be made therein without departing from the spirit and scope of the invention.

What is claimed is:

1. A circuit for generating test video and audio signals comprising:
built into a high definition multimedia interface (HDMI) system;
a video frame generator coupled to a video multiplexer enabling a video transmission signal which is one of an input video signal or an output of the video frame generator; and,
circuitry for outputting the video transmission signal and the audio transmission signal in a high definition multimedia interface (HDMI) format.

2. The circuit of claim 1 further comprising an audio generator coupled to a audio multiplexer enabling an audio transmission signal which is one of an input audio signal or an output of the audio generator, and wherein the circuitry for outputting the video transmission signal is circuitry for outputting both the video transmission signal and the audio transmission signal in a high definition multimedia interface (HDMI) format.

3. The circuit of claim 2, wherein the video frame generator and the audio generator are part of a built-in self-test (BIST) for the circuit.

4. The circuit of claim 2, wherein the audio generator provides a preset audio frequency waveform of variable amplitude.

5. The circuit of claim 1, wherein the video frame generator generates at least one of demonstration patterns and test patterns.

6. The circuit of claim 1, wherein the video frame generator generates test patterns, and wherein the test patterns enable functional checking of the circuit.

7. The circuit of claim 6, wherein the functional check is performed during at least one of manufacturing, field demonstrations, on-site evaluation and on-site adjustments.

8. The circuit of claim 1, wherein the video frame generator generates demonstration patterns, and wherein the demonstration patterns are enabled for pre-sale check and tune-up of the circuit.

9. The circuit of claim 1, wherein the circuitry for outputting the video transmission signal is capable of generating video patterns conforming to any of the HDMI timing formats.

10. An integrated circuit for the transmission of video signals comprising at least the circuit of claim 1.

11. A method for generating test video and audio signals comprising:
within a high definition multimedia interface (HDMI) system;
generating video frames that comprise a plurality of video patterns;
generating an audio signal having a plurality of audio patterns; and,
transmitting the video frames and optionally the audio signal in a HDMI format.

12. The method of claim 11, wherein the video patterns are at least one of: demonstration patterns, test patterns.

13. The method of claim 12, wherein the demonstration patterns are designed to enhance consumer confidence in the performance of a video system.

14. The method of claim 12, wherein the test patterns are designed to enable at least one of: manufacturing debug, field demonstrations, on-site adjustments.

15. The method of claim 14, wherein the test patterns are designed to achieve at least one of: reduction in consumer product return, increase in consumer satisfaction, reduction in sales costs.

16. The method of claim 11, wherein the video patterns and the audio patterns are enabled for pre-sale check and tune-up of a video system.

17. The method of claim 11, further comprising a built-in self-test (BIST) function.

18. A circuit for generating test video and audio signals comprising:
in an integrated circuit for a high definition multimedia interface (HDMI);
a video frame generator coupled to a video multiplexer enabling a video transmission signal which is one of an input video signal or an output of the video frame generator; and,
circuitry for outputting the video transmission signal and the audio transmission signal in a high definition multimedia interface (HDMI) format.

19. The circuit of claim 18 further comprising an audio generator coupled to a audio multiplexer enabling an audio transmission signal which is one of an input audio signal or an output of the audio generator, and wherein the circuitry for outputting the video transmission signal is circuitry for outputting both the video transmission signal and the audio transmission signal in a high definition multimedia interface (HDMI) format.

20. The circuit of claim 19, wherein the video frame generator and the audio generator are part of a built-in self-test (BIST) for the circuit.

21. The circuit of claim 19, wherein the audio generator provides a preset audio frequency waveform of variable amplitude.

22. The circuit of claim 18, wherein the video frame generator generates at least one of demonstration patterns and test patterns.

23. The circuit of claim 18, wherein the video frame generator generates test patterns, and wherein the test patterns enable functional checking of the circuit.

24. The circuit of claim 23, wherein the functional check is performed during at least one of manufacturing, field demonstrations, on-site evaluation and on-site adjustments.

25. The circuit of claim 18, wherein the video frame generator generates demonstration patterns, and wherein the demonstration patterns are enabled for pre-sale check and tune-up of the circuit.

26. The circuit of claim 18, wherein the circuitry for outputting the video transmission signal is capable of generating video patterns conforming to any of the HDMI timing formats.

27. An integrated circuit for the transmission of video signals comprising at least the circuit of claim 18.

28. A method for generating test video and audio signals comprising:
in an integrated circuit implementing a high definition multimedia interface (HDMI);
generating video frames that comprise a plurality of video patterns;
generating an audio signal having a plurality of audio patterns; and,
transmitting the video frames and optionally the audio signal in a HDMI format.

29. The method of claim 28, wherein the video patterns are at least one of: demonstration patterns, test patterns.

30. The method of claim 29, wherein the demonstration patterns are designed to enhance consumer confidence in the performance of a video system.

31. The method of claim 29, wherein the test patterns are designed to enable at least one of: manufacturing debug, field demonstrations, on-site adjustments.

32. The method of claim 31, wherein the test patterns are designed to achieve at least one of: reduction in consumer product return, increase in consumer satisfaction, reduction in sales costs.

33. The method of claim 28, wherein the video patterns and the audio patterns are enabled for pre-sale check and tune-up of a video system.

34. The method of claim 28, further comprising a built-in self-test (BIST) function.
